(19) United States
(12) Patent Application Publication
(10) Pub. No.: US 2009/0006940 A1
(43) Pub. Date: Jan. 1, 2009

(54) Simplified Persona Selector and Indication System

(76) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(21) Appl. No.: 12/163,240

(22) Filed: Jun. 27, 2008

Related U.S. Application Data
(60) Provisional application No. 60/946,498, filed on Jun. 27, 2007.

(51) Int. Cl. G06F 17/00

(52) U.S. Cl. 715/224

(57) ABSTRACT

A system and method of enhanced user interaction with an identity agent makes use of in-form icons and actions to invoke the identity agent persona selection mechanisms.

### CROSS REFERENCE TO RELATED APPLICATIONS

This application claims the benefit of U.S. Provisional Application No. 60/946,498 the contents of which are incorporated herein by reference in their entirety.

### FIELD OF THE INVENTION

The present invention relates generally to identity management. More particularly, the present invention relates to identity agents and user interaction with identity agents.

### BACKGROUND OF THE INVENTION

In electronic systems, user identity information is obtained and stored by service providers during the creation of user accounts. These accounts allow users to store information, obtain service, and otherwise interact with a service.

From the perspective of a user, providing the same identity information to many different services is troublesome, and is often an impediment that results in either a reluctance to use a service or entry of inaccurate identity information (either through error or through intention).

Identity providers and identity agents make use of an identity infrastructure for a number of different tasks including allowing users to provide stored identity information to different service providers without having to reenter the data for each service provider. Identity agents are also used to manage user logins to various services. When done through an identity management network, the login information can be provided through a single sign on service.

In an attempt to provide users with the ability to bypass registration forms, and to manage the ever-expanding number of username and password combinations associated with different service providers, solutions have arisen that can best be characterized as form filling applications.

Some examples of these applications rely on a guessing algorithm that attempts to map known information to the names associated with various fields in a form, while others make use of an administered central database of known forms that houses a mapping between known identity information and the fields on the form associated with the requested information. One skilled in the art will appreciate that a combination of the two approaches can also be used.

Many such form filling applications are provided to users in the form of toolbars, that allow a user to click on a toolbar button to fill in the best guess or mapped information. Due to the simplicity of their design, it is rare that these applications store more than a single set of identity data associated with a persona. This is often inadequate for a user who may use different persona for different aspects of his online usage. Additionally, typically only one set of login data, if any, is stored. Accordingly, users with multiple logins to a particular service cannot adequately make user of the form filling or login management.

It is, therefore, desirable to provide an identity management solution that allows for multiple personas and permits ease of use from the user perspective.

### SUMMARY OF THE INVENTION

One object of the present invention to obviate or mitigate at least one disadvantage of previous identity management or form filling tools.

In a first aspect of the present invention, there is provided an identity agent. The identity agent has access to identity information stored as data elements defined by an identity schema and provides visual cues indicative of a status. The agent comprises a form recognition engine, a form mapping retrieval engine, a status analyzer and a display engine. The form recognition engine parses received content to detect a form. The form mapping retrieval engine obtains a mapping associated with the detected form. The status analyzer determines the status in accordance with the obtained mapping and the identity information. The display engine displays a visual cue indicative of the determined status.

In an embodiment of the first aspect of the present invention, the recognition engine includes a hypertext parsing engine for parsing received hypertext markup language content to detect tags indicative of a form. In another embodiment, the form mapping retrieval engine includes a communications interface for requesting a form mapping from a remote database, optionally the communications interface requests form mappings from the remote database through a web browser. In another embodiment, the form mapping retrieval engine includes a local mapping data interface for retrieving form mappings from a local database of form mappings, and can also include a mapping generator for generating a mapping based on a best-guess analysis of the detected form. In further embodiments of the first aspect of the present invention, the status analyzer determines the status independently for each field in the form. In another embodiment, the determined status is selected from a list that can includes such statuses as: unmapped form, mapping complete with data available, mapping complete with data unavailable, mapping incomplete with data available, mapping incomplete with data unavailable, mapping incomplete with multiple data option available and mapping complete with multiple data options available. In further embodiments, the status analyzer includes both a comparator for comparing the accessible data elements to elements of a schema referenced in the retrieved mapping, and a status determinator for determining the status in accordance with the output of the comparator. In another embodiment the visual cue is selected from a list including an icon representing the existence of a mapping for which there is a corresponding data element and an icon representing the existence of a mapping for which there is no corresponding data element.

In a second aspect of the present invention, there is provided a method for indicating the status of a form mapping that associates a form field with an element in an identity schema. The method comprises the steps of receiving a form having a form field; determining a status in accordance with the availability of a mapping associated with the received form, and the availability of at least one data element corresponding to the element in the identity schema mapped to the form field; and modifying a rendering of the form to providing a visual cue indicative of one of at least three statuses.

In an embodiment of the second aspect of the present invention, the step of determining includes requesting a form mapping from a mapping repository to determine the availability of the mapping. In a further embodiment, the determined status is selected from a list that includes options such as: unmapped, mapping available with corresponding data elements available, mapping available with corresponding data elements available, mapping available with multiple corresponding data elements available, mapping incomplete with corresponding data elements available and mapping incomplete with corresponding data elements unavailable. In a further embodiment, the step of modifying includes at least one of inserting an icon into the form field to indicate at least one of the at least three statuses and altering a background color in the form field to indicate at least one of the at least three statuses. In a further embodiment the step of determining includes determining that the form field has been filled with a data element corresponding to the element in the identity schema mapped to the form field, and setting the status as mapping available and field filled with identity data.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a method of the present invention;

FIG. 2 is a flowchart illustrating a method of the present invention;

FIG. 3 is a screen capture illustrating a login page displayed in conjunction with an identity agent of the present invention;

FIG. 4 is a screen capture illustrating an identity agent of the present invention providing the user with a selection of two known logins;

FIG. 5 is a screen capture illustrating an identity agent of the present invention indicating that a form is recognized and profile information corresponding to the form fields is known;

FIG. 6 is a screen capture illustrating an identity agent of the present invention requesting a user selection of a persona for a profile request;

FIG. 7 is a screen capture illustrating an identity agent of the present invention allowing a user to replace a suggested value with another known value;

FIG. 8 is a screen capture illustrating the result of an identity agent of the present invention changing a single entry in a profile request;

FIG. 9 is a screen capture illustrating an identity agent of the present invention indicating that a stored value corresponding to the requested information is available;

FIG. 10 is a screen capture illustrating an identity agent of the present invention providing a pick list of known values for a requested field;

FIG. 11 is a screen capture illustrating an identity agent of the present invention indicating both that a form mapping is known and that data for some of the form fields is known;

FIG. 12 is a screen capture illustrating an identity agent of the present invention providing the user with a pick list of personas;

FIG. 13 is a screen capture illustrating an identity agent of the present invention after providing information corresponding to a selected persona indicating that various fields can be filled with other information;

FIG. 14 is a screen capture illustrating an identity agent of the present invention providing a pick list of known values for a requested field;

FIG. 15 is a screen capture illustrating an identity agent of the present invention after substituting one known value for another in the example of FIG. 14;

FIG. 16 is a block diagram illustrating an embodiment of an identity agent of the present invention.

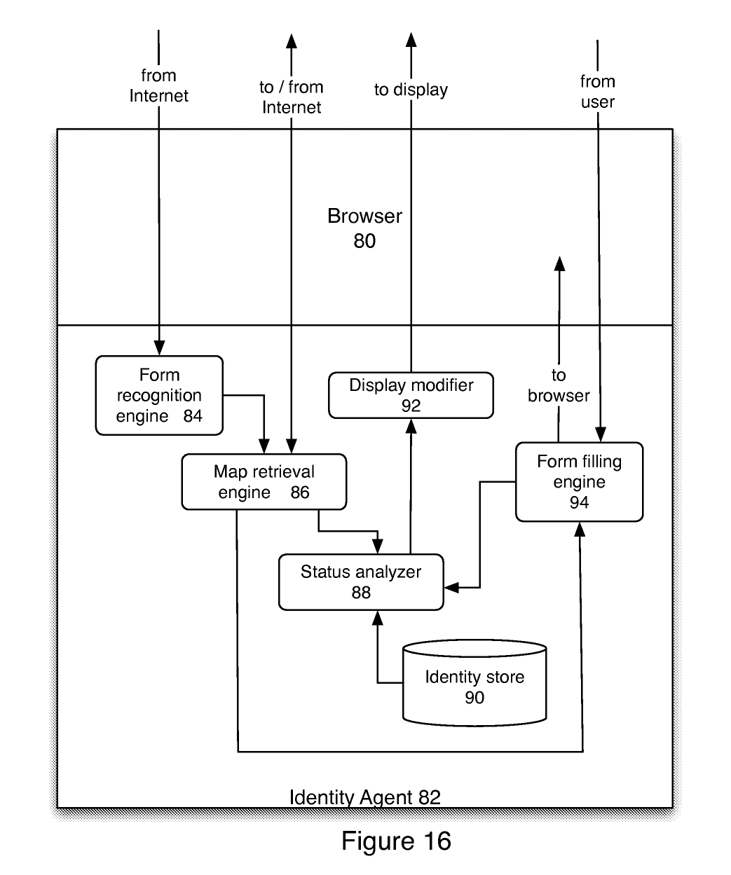

### DETAILED DESCRIPTION

Generally, the present invention provides a method and system for enhancing the interaction of a user with elements of an identity management network, including an identity agent.

Identity management networks and identity agents benefit from an efficient and streamlined user experience. When user interaction with them results in a positive experience and provides a net benefit, users will be more inclined to continue their use. Service providers are often unwilling to join an identity management network, or are unwilling conform their sites to standards required by identity agents unless there is a large user base for the tools. Users are influenced to use identity tools by both the improved user experience and the number of service providers that interact with the identity tools. Thus, building a user base is a difficult but necessary task to promote the acceptance of identity tools. The improvement of the user experience, as it applies to the use of an identity agent, can lead to the growth of a user base, especially if the identity agent is able to interact with existing service providers to allow user management of identity information.

The use of identity agents results in a user base that is trained to interact with identity information in a certain fashion. By making it easier to interact with the identity information requests and providing a standardized approach to receiving and responding to requests for identity information, an identity agent can build a better experience for users, and create an environment that is more encouraging for service providers to enter.

Prior art form-filling applications have typically required that the user activate either a control located in either the browser chroma or a control located in a toolbar in the browser chroma. This requires that the user refocus his attention to another portion of the display to determine if the form on a page has been recognized by the form-filler. Furthermore, form filling applications have not typically focused on the management of different personas, and thus do not provide users the option of keeping independent sets of identity information that can be selected from for filling in a form. Existing form filling applications do not properly handle the situation of a user having multiple login accounts for a single service provider.

In the present invention, a form status is determined and displayed to the user in an unobtrusive manner to allow to user to quickly see if form mappings are available, and if the data required by the form is available to the identity agent. In one embodiment, an icon is displayed in the form field indicating that a mapping is available. This indication can be provided on a field-by-field basis so that a user will be able to see if a form is fully mapped or partially mapped. The indicator can be modified to reflect different statuses. In one example the icon can be displayed to show that a mapping between a form field and an element of the stored identity information schema is known. If no mapping is known, no icon is displayed. The icon can be rendered in color to show that the mapping is known, and the required data is available. The icon can be displayed in black-and-white or grayed out to show that a mapping is known, but the requested information is not available. The icon can be displayed in a different location in the form field if the field has been filled in by the identity agent.

The user can invoke different identity agent actions by clicking on the displayed icon, or by right-clicking on the displayed icon and selecting an option from a context sensitive menu. In conjunction with other identity agent features, including the ability to store identity information in a series of persona profiles, the user can be provided with a simplified interface to the identity agent.

Embodiments of the identity agent of the present invention can be provided in a number of different forms. The identity agent can be a standalone application executed on a computer platform, it can be an integral part of a web browser a web browser plugin, or an extension to a web browser. The identity agent is able to interact with a web browser to detect identity transactions, and to allow the identity agent to modify the manner in which a webpage is displayed. The identity agent can interact with the user through either its own user interface, or through the interface of the web browser, and it has access to an identity store for storing user identity information in a defined identity schema. Those skilled in the art will appreciate that various modifications to the above described agent can be made without departing from the scope of the present invention.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

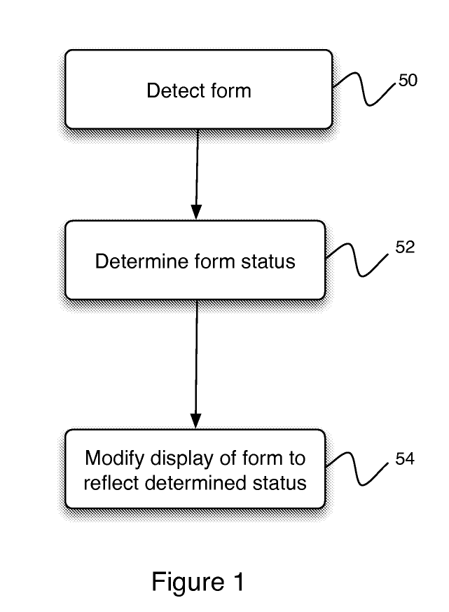

FIG. 1 is a flowchart illustrating a method of the present invention. In step 50, the identity agent detects that the web browser has received a form. This can be done in a number of different ways, including through the analysis of the received webpage to detect tags indicative of a form. Upon detection of a form, the status of the form, or its respective fields, is determined in step 52. The webpage is then displayed in step 54 with a modification applied to the form to indicate the determined status.

The form mapping relates fields in the form to elements of the identity schema. The identity agent uses the mapping to identify which elements of the identity schema are being requested by the form, and then can prompt the user for authorization to fill in the form using the available information. Where a user has grouped identity information into personas, so that a different set of identity information can be used for different service providers (to provide, for example a professional persona, a personal persona, and an anonymous persona for submitting obfuscated data), the identity agent can provide the user with the ability to select between different personas when profile data is requested. Similarly, where multiple logins are available they can be separately stored to allow the user to select a desired login from the login page.

The status of the form can be determined for the whole form or it can be determined on a field by field basis. In some embodiments, the form can be considered to be comprised of only the fields for which a mapping is available, in which mappings will always be considered to be complete. In the exemplary embodiment described below, forms can be partially mapped, which indicates that a mapping has been created that associates some form fields to elements in the identity schema, but leaves other fields in the form unmapped. This may be a result of poor mapping, or a conscious decision due to the fact that there is no identity schema element that is appropriate for mapping to the particular field, one example of such a field is for verification fields that require user input to respond to a one-time challenge.

The status can include more information than simply whether or not a mapping exists. The status of a field can also include information about whether or not the required identity schema element is available to the identity agent, and whether the field has already been populated with information by the identity agent. Forms can also be grouped into form types, with the types forming part of the status. The number of different form types can vary by implementation, but can include some or all of, a login form type, a registration form type, and a profile form type. Other types of forms can be added to the list without departing from the scope of the present invention.

The identity agent, upon determining the status of a form, then modifies the display of the form so that a visual cue indicating the determined status is provided to the user. In one embodiment, an icon is employed to indicate the determined status. When a field has a mapping and the identity schema element associated to the field by the mapping is populated the icon can be displayed in color. If the field is mapped to an identity schema element for which no data is available, a modified icon can be displayed. One example of the modified icon, indicating that the mapping is available but the corresponding data is not, is a black-and-white or grayscale version of the icon.

Modifications to a standard icon, use of different icons, or colorization of form fields can all be employed as visual cues, as can other cues that will be apparent to those skilled in the art.

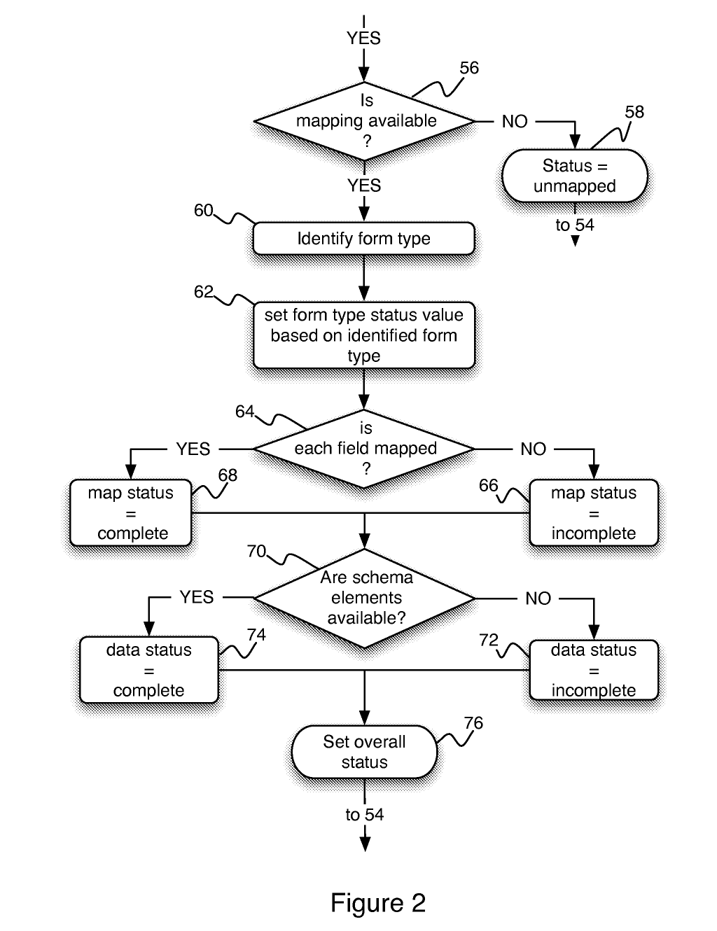

FIG. 2 is a flowchart illustrating an exemplary method of determining a status in step 52 of FIG. 1. In step 56 a determination is made as to whether a mapping for the form is available. The determination can be made by attempting to retrieve the form from either a central mapping database, from a local mapping database, or from a combination of the two. If the identity agent makes use of a best guess algorithm to create mappings and does not rely upon a database of mappings, best guess algorithm can be run, and the determination of step 56 can then be attempted. If no mapping is available for the received form, the overall status is set to unmapped, indicating that no mapping is available. The process then terminates and proceeds to step 54 in FIG. 1. If a mapping is available, the type of form mapping is determined in step 60 and the form type status is set in step 62. Examples of form types are provided above. In step 64 a determination of whether or not each form field has a mapping to an identity schema element is made. If not every field is mapped, the mapping status is set to incomplete in step 66. If every field in the form is mapped, the status is set to complete in step 68. In step 70 the identity agent determines whether all schema elements that a mapping points to are available. If not all the elements are available, the data status is set to incomplete in step 72, otherwise the data status is set to complete in step 74. In step 76, the overall status is set as a combination of the previous status values.

One skilled in the art will appreciate that in different embodiments of the present invention, different values can be examined and aggregated to determine the overall status. The above described method is intended to be exemplary of one embodiment of the present invention and should not be taken as being restrictive of the scope of the present invention. The smaller status values, such as the mapping status, the data status and the form type, should not be considered to be the only types of status values that can be determined, nor should they be considered as the values that must be determined.

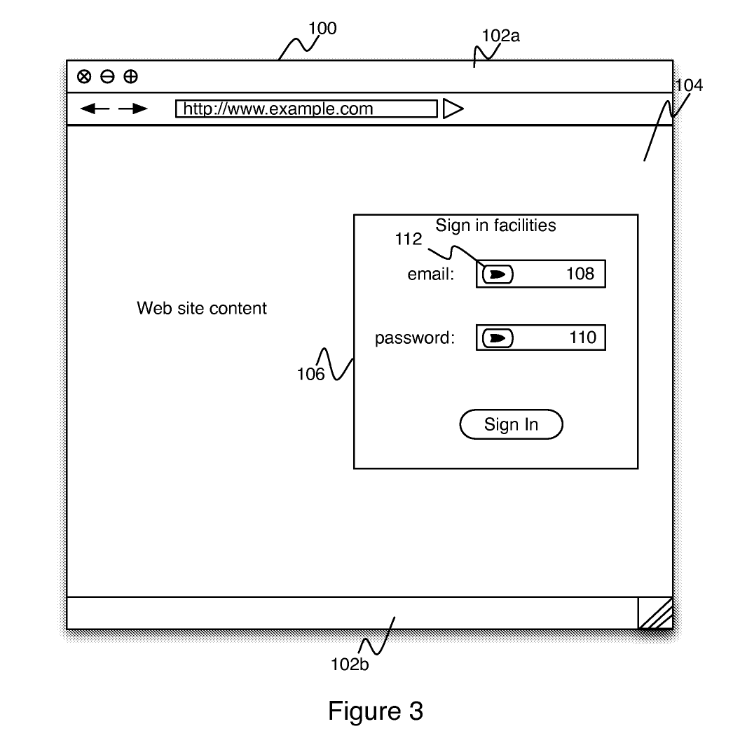

As noted above, the present invention can provide users a subtle but clear indication that a mapping is known for a form. One such indication is illustrated in FIG. 3. FIG. 3 illustrates a web browser 100 having a browser chroma 102 containing both a top portion 102a which includes an address bar, and a bottom portion 102b which contains displayed page status information. The display portion 104 of the browser 100 displays a rendering of the received webpage. On the illustrated page, a form 106 has been detected. There are two fields on the form, an email field 108 and a password field 110. Upon detecting the form, the identity agent of the present invention determined the status of fields 108 and 110 in form 106, and determined that there is a mapping and the identity schema elements associated with the form fields 108 and 100 in the mapping are available. As a result, icon 112 is displayed to indicate the determined status. If the identity schema elements required by the form 106 were not known an alternate cue would be provided as discussed above. When a user activates the identity agent, which can be done in some embodiments by clicking in either of fields 108 or 110, a login interface is displayed by the identity agent.

As noted above, visual cues are applied within the browser display 104 as opposed to in the browser chroma 102. The cues can also be used to invoke the identity agent, as opposed to requiring a user to use a control that is embedded in the browser chroma, or in menus. In addition to modifying the manner in which the rendered web page is displayed, the identity agent can provide an activation mechanism in the browser display 104 instead of in the chroma 102. Thus, a user can activate the identity agent through an action as simple as clicking on a mapped form field such as either of fields 108 and 110.

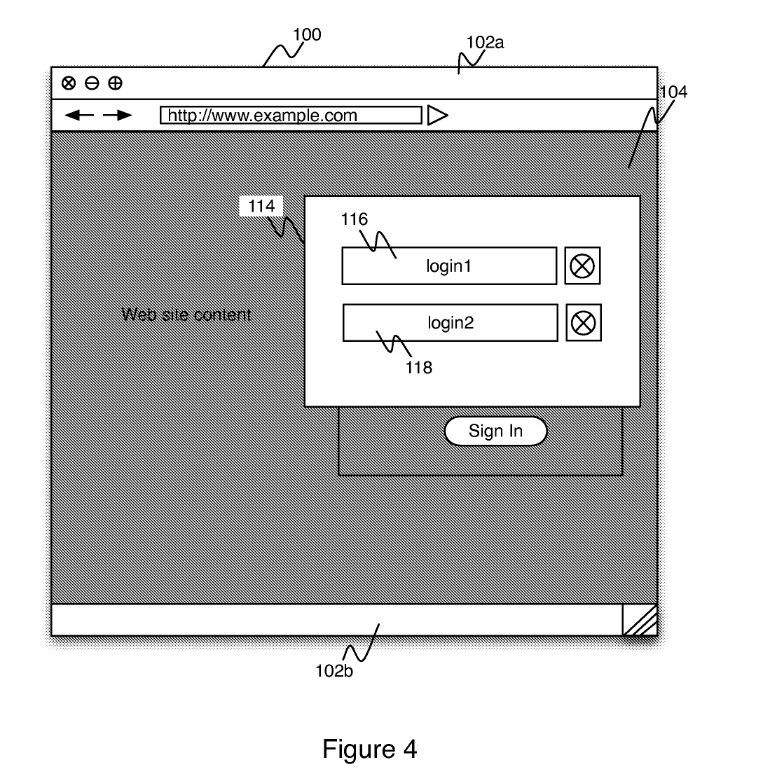

The form 106 of FIG. 3 can be identified as a login form type. When the user activates the identity agent the identity agent can provide a further visual cue indicating the form type, as illustrated in FIG. 4. The identity agent of the present invention changes the display of the webpage rendered by Browser 100, having chroma 102, in display 104 to include a login selector 114. The login selector 114 is displayed because the form type in the status, determined when the form was received, indicates that the form is a login page. Login selector 114 is a pick list allowing a user to select which stored login is used for the site. Two stored logins, 116 and 118 are provided. The user can be given the ability to select one of the logins by clicking on it. The username and password associated with the login are stored so that they are accessible to the identity agent. The logins 116 and 118 can be differentiated on the basis of the username associated with each login, or in an alternate embodiment, the identity agent can provide the user the ability to assign descriptions to each of the logins. Users can be provided with the ability to delete a login from the identity store accessed by the identity manager from the login selector 114.

Upon the user selecting one of login 116 and login 118, the identity agent will fill the corresponding username and password information into fields 108 and 110 respectively, and the completed form 106 can then be submitted. An auto submit feature can also be enabled so that after selecting a login from the pick list, the form is both automatically filled and automatically submitted.

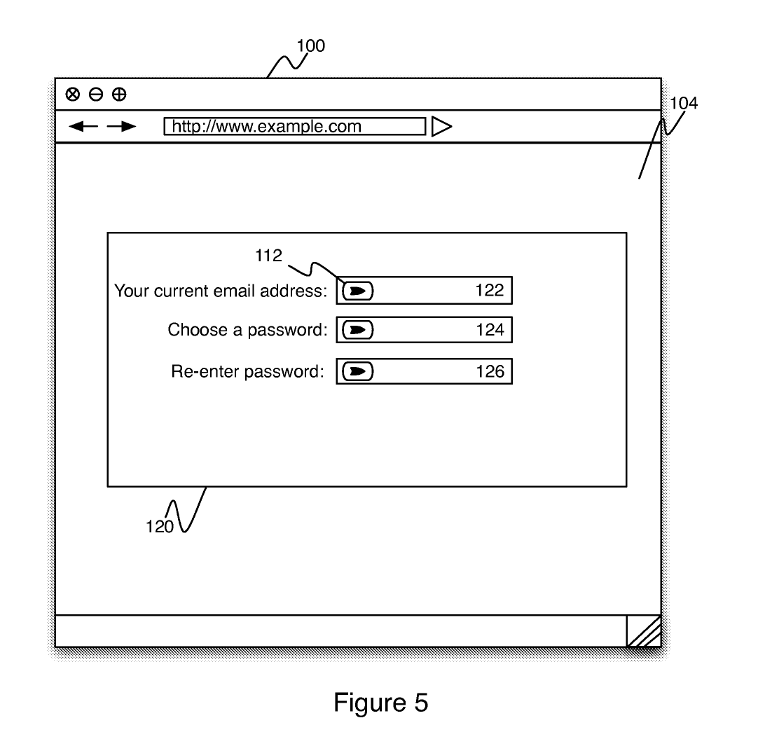

FIG. 5 illustrates a registration type form for which a mapping is known, snf the required identity schema elements are available. As illustrated, browser 100 renders the received form 120 in display 104. The display of the rendered form is modified by the identity agent to reflect the determined status. Form 120 is a registration form having multiple fields including fields 122 which requests an email address, field 124 which requests a password, and field 126 which requests confirmation of the password provided in field 124. All this information is available to the identity agent, and thus an icon is provided in each of fields 122 124 and 126 to indicate that a mapping between known identity information and the form field is known.

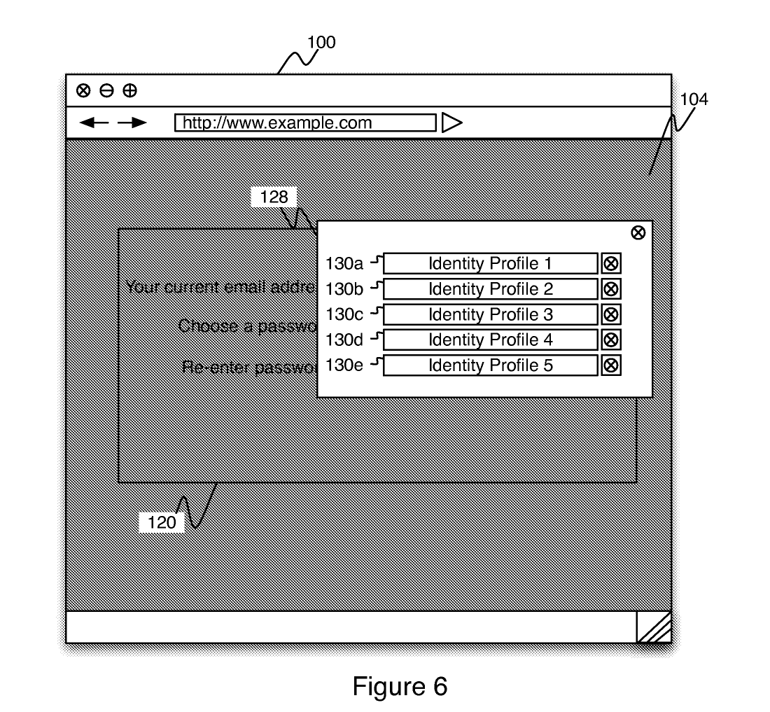

FIG. 6 illustrates the result of activating the identity agent from form 120 of FIG. 5. Whereas in FIG. 4 a login selector was displayed, in FIG. 6 a persona selector 128 is displayed in the display 104 of browser 100. The persona selector 128 is overlaid on form 120, and in this case specifically on fields 122 124 and 126. The identity agent allows the user to group certain sets of identity information together to create personas. This allows different addresses, phone numbers, email addresses and other identity information to be maintained and conveniently accessed by the user. The persona selector 128 allows the user to select between one of a number of personas 130a-130e. These personas can have overlapping identity information, or they can be distinct. When a user selects a persona 130 from the pick list provided in persona selector 128, the identity information associated with fields 122, 124 and 126 is filled in.

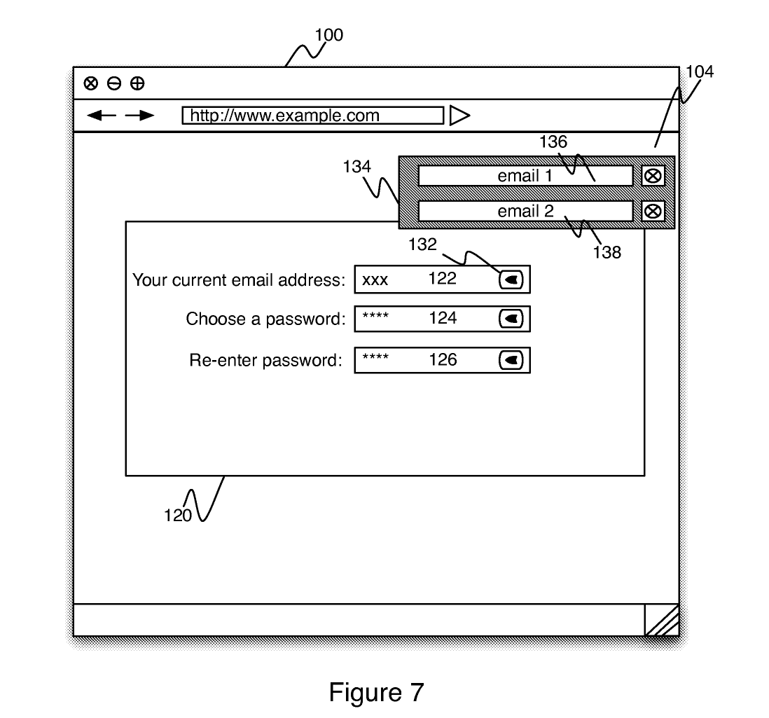

Because it is a registration form, the identity agent does not necessarily submit the form. The user can be provided with the ability to modify the preselected information. As illustrated in FIG. 7, display 104 shows the information associated with the selected persona in fields 122, 124 and 126. At this point, the identity agent can change the status of fields 122, 124 and 126 of form 120 to reflect the fact that they have been filled in by the identity agent, but other values are available in the identity schema. Browser 100 indicates this new status by displaying icon 132 in the filled in fields of form 120 on display 104. It should be noted that in the illustrated embodiment, icon 132 is similar to icon 112, but is displayed in the far right of the field instead of the far left of the field, and has been horizontally flipped. Additionally, the background of fields 124 and 126 can be colored to reflect the fact that the data in them has been provided by the identity agent. If the user wants to override the filled-in information, he can activate an element selector 134 by clicking on icon 132 in the field that the user wants to change the information. The element selector 134 provides the user the ability to select new values from the identity store to be filled into relevant field. In the illustrated embodiment, the user has selected the email address field 122, and element selector 134 indicates the availability of email address 136 and option 138. If neither of these options retrieved from an identity store is correct, the user can cancel the element selector 134 through use of a standard control. The user can then manually enter the information into field 122.

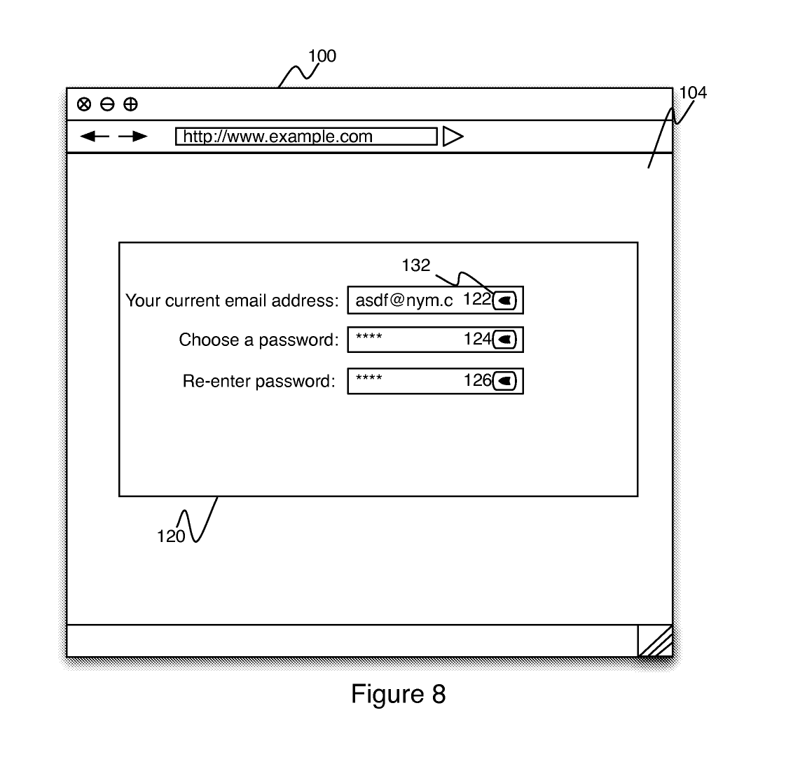

FIG. 8 illustrates the result of selecting email address 132 from the element selector in FIG. 7. Browser 100 shows form 120 in display 104. Each of fields 122, 124 and 126 are colored to indicate that the value that is presently in the field has been filled in by the identity agent, and have icon 132 on the right side indicating that they have been filled in.

Another form field that can have multiple values associated with it is the password field. In a presently preferred embodiment, when the user is on a form that has been recognized as a registration type form, the identity agent can provide the option of a randomly generated password. It is well known to many skilled in the art that users often do not remember passwords, and as such rely on a small number of insecure passwords for most services that they use. To combat this, complex and secure passwords can be stored by the identity agent in the identity store. This provides a degree of security, but the user is not required to remember the randomly generated password. One drawback to this is that the user will often have difficulty with this password if access to the service is required from a computer that does not have access to the identity agent. To address this, the user can override the randomly generated password to put in another password. The identity agent can store a hint associated with each user-defined password, so that if an element selector is displayed, the hint associated with the user defined password is presented instead of the password itself. This provides a degree of security from a third party looking over a shoulder, or gaining access to the identity agent to learn user passwords. One skilled in the art will appreciate that the displaying of the password hints is a presently preferred, but still optional, embodiment of the present invention.

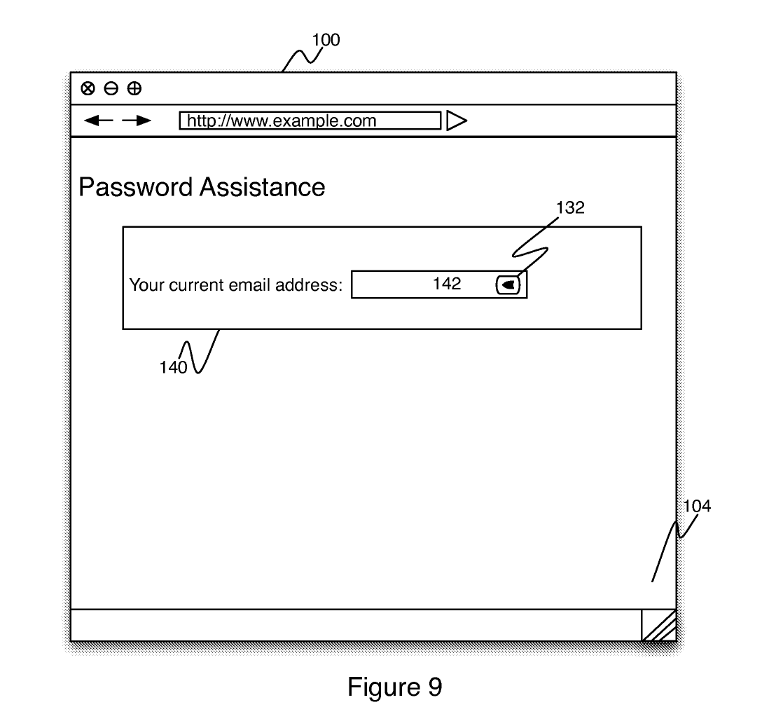

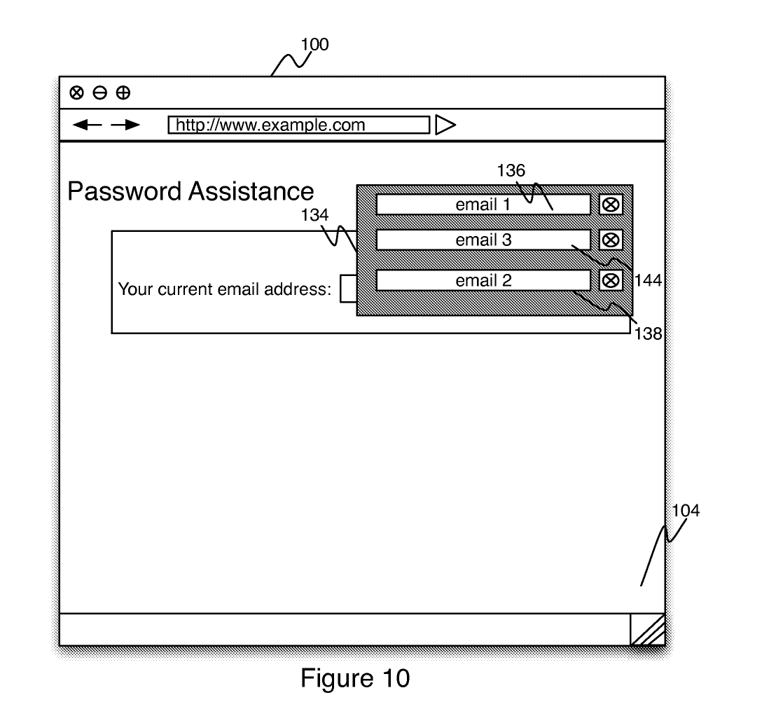

In FIG. 9 browser 100 has rendered a form 140 in display 104. Form 140 is requesting profile information (in this case an email address in field 142). Because a single element of profile information from the identity schema is requested, the identity agent can mark the field 142 as having a known map, and having the multiple values for the information requested by displaying icon 132. When a user activates the identity agent, instead of presenting a persona selector, the identity agent provides the user with element selector 134 as illustrated in FIG. 10. Element selector 134 shows the various options that are associated with this field, including email addresses 136 and 138 as before, but adding email address 144 which was submitted as an email address in field 122 of FIG. 8. Similarly, if a postal code were requested, the user would be presented with an element selector that provided a pick list of known postal codes. This allows identity information to be grouped together to form a persona, but when the identity agent is presented with a request for a single element, it can provide the user a different view of the data available from the identity store. This allows the identity agent to provide a more relevant element selector.

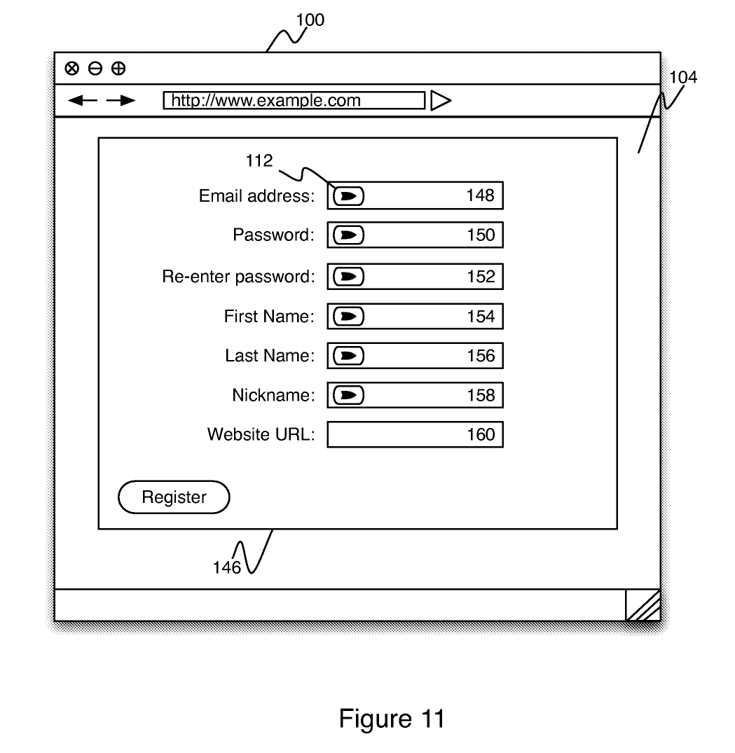

In FIG. 11, browser 100 shows form 146 in display 104. The identity agent has modified the display of fields 148, 150, 152, 154, 156 and 158 of form 146 to display icon 112 in each of the fields. The form mapping associated with form 146 does not map field 160 to an element in the identity schema. As a result, field 160 is not modified.

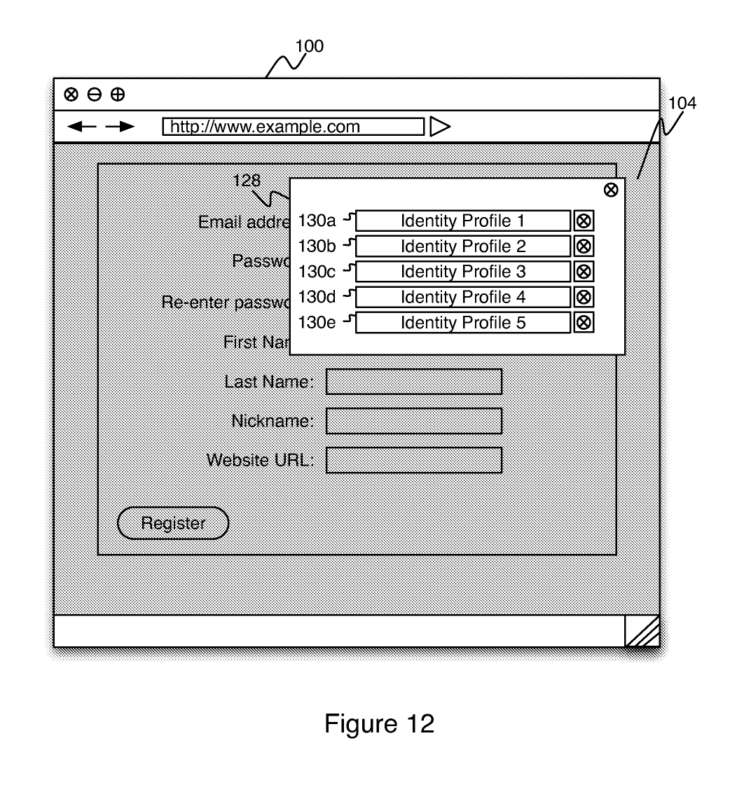

FIG. 12 illustrates the further modification to the display of the form in FIG. 11 resulting from the user activating the identity agent by clicking on icon 112. The result is the display of persona selector 128 providing the user with the option to select personas 130a-130e.

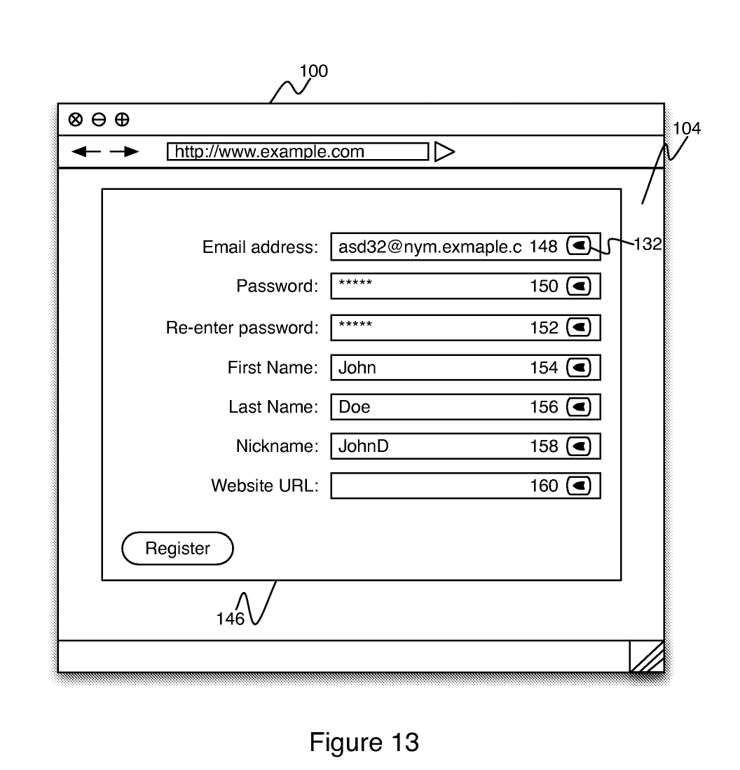

As shown in FIG. 13, after the user selects a persona from persona selector 128, fields 148-158 are filled in using default values retrieved from the identity store in accordance with a mapping. Icon 132 is displayed in the fields that have been filled in to indicate that the profile data has been entered, but more options are available. Field 160 remains unchanged.

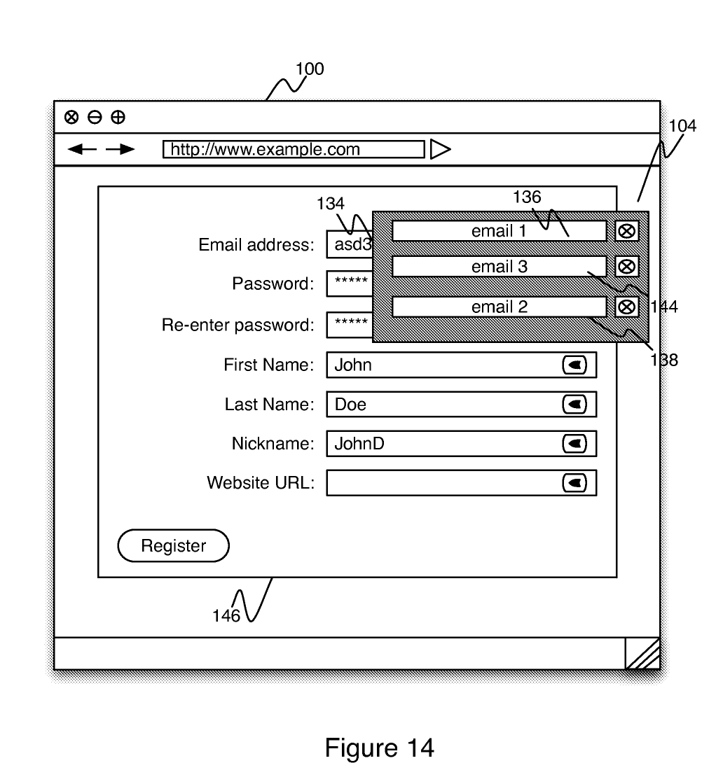

A user can click in one of the filled in fields of this registration page to activate an element selector 134 as illustrated in FIG. 14. Browser 100 shows form 146 in display 104. The identity agent has modified the display of some of the fields of form 146, and in response to user activation has provided element selector 134 to allow the user to select an alternate email address to provide in the form. Element selector 134 provides the user with the ability to select email addresses 136, 138 and 148.

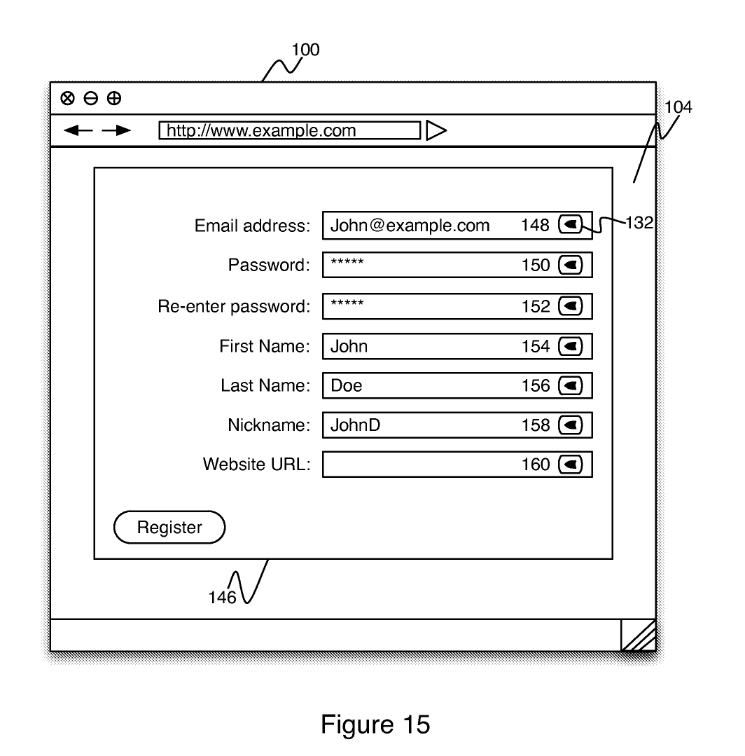

FIG. 15 illustrates the result of the user selecting email address 138 from the element selector 134 in FIG. 14. As a result of that selection, browser 100 shows form 146 in display 104, with the values filled in by the identity agent. Form fields filled in by the identity agent (fields 148-150) have had their backgrounds colored in to indicate that fact, and they all display icon 132 to indicate that other values are available in each of the fields. Field 160 remains unchanged, and the user has the ability to manually fill in the field before finishing the registration process.

One skilled in the art will appreciate that the identity agent provides a number of enhanced user interaction elements including the ability to directly select a persona without having to use a drill-down menu or tab system, the ability to modify single elements in filled-in forms so that another stored value can be submitted, and the ability to modify the indication method to provide information otherwise not available.

Whereas prior art form filling applications can often recognize forms, and make best guesses to their mappings, indications are often only provided when the field is recognized and data is present. In the present invention, a number of different notifications are provided so that the identity agent can provide different levels of information other than binary information provided in the prior art. In one embodiment, a grayed out icon embedded into the field can indicate that a mapping is known, but the required data is not known, an icon left justified and illuminated can indicate that a mapping is known and the required data is stored, an icon that is right justified can indicate that other values to the field are known and available, and a coloring applied to the form fields can be used to indicate that the data in the field was provided by the Identity Agent. In other embodiments of the present invention, the mechanisms by which the varied levels of indication are provided, and the type of information being indicated, can vary. In a further embodiment, icons indicating a mapping can fade away if the identity agent is not activated so that the user is not distracted. This can be done after a predefined period of time after which it can be safely assumed that the user is not interested in submitting identity information. It will be understood by those skilled in the art that the identity agent can still be activated, either through a secondary action or through an action in the chroma or in the toolbar if the user does determine that a submission of identity information is desired.

FIG. 15 illustrates an exemplary embodiment of the present invention using functional elements. Those skilled in the art will appreciate that functional elements can be combined with each other, or a functional element can be split into two or more functional elements, or be spread across other existing elements, without departing from the scope of the present invention. A web browser 80 interacts with the other systems through its connection to a data network, such as the Internet. Identity agent 82 communicates with Browser 80, and may rely upon browser 80 for its input and output functionality. As such, Identity agent 82 can be implemented as a web browser plugin or extension. As web pages are retrieved from the Internet they are analyzed by form recognition engine 84 to detect the presence of a form. The techniques used for form recognition engine 84 can vary, but may include a parsing of HTML received by the browser to detect the mark-up tags used to denote forms and fields. When a form is recognized, map retrieval engine 86 retrieves a mapping for the recognized form. One skilled in the art will appreciate that though the illustrated embodiment of the preset invention indicates that map retrieval is done through a connection to a remote networked node, the present invention can be implemented by making use of a local map database, a mapping algorithm, or any combination thereof. Upon retrieval of the map by map retrieval engine 86, status analyzer 88 determines the status of the mapping as described above. This determination is done through an analysis of the map and the data available in identity store 90. The determined status is provided to display modifier 92 which modifies the manner in which a form is displayed to provide visual cues indicating the status of the mapping. Users can control form filling engine, either through direct access or through an interface provided by browser 80. The operation of the form filling engine which makes use of the mapping retrieved by the map retrieval engine 86 and the identity data housed in the identity store 90, is not germane to the operation of the identity agent 82 as a whole. Various implementations of the form filling engine 94 be used without departing from the scope of the present invention. In a presently preferred embodiment, when form filling engine 94 fills data into a form, it provides an indication of this to the status analyzer 88 so that the status of the mapping can be updated, and the display modified as needed.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An identity agent, having access to identity information stored as data elements defined by an identity schema, for providing visual cues indicative of a status, the agent comprising:
a form recognition engine for parsing received content to detect a form;
a form mapping retrieval engine for obtaining a mapping associated with the detected form;
a status analyzer for determining the status in accordance with the obtained mapping and the identity information; and
a display engine for displaying a visual cue indicative of the determined status.

2. The identity agent of claim 1 wherein the recognition engine includes a hypertext parsing engine for parsing received hypertext markup language content to detect tags indicative of a form.

3. The identity agent of claim 1 wherein the form mapping retrieval engine includes a communications interface for requesting a form mapping from a remote database.

4. The identity agent of claim 3 wherein the communications interface requests form mappings from the remote database through a web browser.

5. The identity agent of claim 1 wherein the form mapping retrieval engine includes a local mapping data interface for retrieving form mappings from a local database of form mappings.

6. The identity agent of claim 1 wherein the form mapping retrieval engine includes a mapping generator for generating a mapping based on a best-guess analysis of the detected form.

7. The identity agent of claim 1 wherein the status analyzer determines the status independently for each field in the form.

8. The identity agent of claim 1 wherein the determined status is selected from a list including: unmapped form, mapping complete with data available, and mapping complete with data unavailable.

9. The identity agent of claim 8 wherein the list further includes: mapping incomplete with data available, mapping incomplete with data unavailable, mapping incomplete with multiple data option available and mapping complete with multiple data options available.

10. The identity agent of claim 1 wherein the status analyzer includes a comparator for comparing the accessible data elements to elements of a schema referenced in the retrieved mapping, and a status determinator for determining the status in accordance with the output of the comparator.

11. The identity agent of claim 1 wherein the visual cue is selected from a list including an icon representing the existence of a mapping for which there is a corresponding data element and an icon representing the existence of a mapping for which there is no corresponding data element.

12. A method for indicating the status of a form mapping that associates a form field with an element in an identity schema, the method comprising:
receiving a form having a form field;
determining a status in accordance with the availability of a mapping associated with the received form, and the availability of at least one data element corresponding to the element in the identity schema mapped to the form field; and
modifying a rendering of the form to providing a visual cue indicative of one of at least three statuses.

13. The method of claim 12 wherein the step of determining includes requesting a form mapping from a mapping repository to determine the availability of the mapping.

14. The method of claim 12 wherein the determined status is selected from a list including: unmapped, mapping available with corresponding data elements available, and mapping available with corresponding data elements available.

15. The method of claim 14 wherein the list further includes: mapping available with multiple corresponding data elements available, mapping incomplete with corresponding data elements available and mapping incomplete with corresponding data elements unavailable.

16. The method of claim 12 wherein the step of modifying includes inserting an icon into the form field to indicate at least one of the at least three statuses.

17. The method of claim 12 wherein the step of modifying includes altering a background color in the form field to indicate at least one of the at least three statuses.

18. The method of claim 12 wherein the step of determining includes determining that the form field has been filled with a data element corresponding to the element in the identity schema mapped to the form field, and setting the status as mapping available and field filled with identity data.
